(19) United States
(12) Patent Application Publication
(10) Pub. No.: US 2009/0195159 A1
(43) Pub. Date: Aug. 6, 2009

(54) LED COOLING SYSTEM

(76) Inventor: Jerry L. Smith, Hesperia, CA (US)

Correspondence Address: DONALD W. MEEKER, 924 EAST OCEAN FRONT, # E, NEWPORT BEACH, CA, 92661, US

(21) Appl. No.: 12/025,038

(22) Filed: Feb. 3, 2008

(51) Int. Cl. F21V 29/02

(52) U.S. Cl. 315/33

(57) ABSTRACT

A self contained High Power LED cooling system has a connected LED chip, heat radiator, fan, and self-containing power supply. The components are interconnect by spring loaded posts to absorb temperature expansion. A thermocouple device monitors the temperature to shut off the LED chip before reaching a critical temperature.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH OR DEVELOPMENT

Not applicable.

### BACKGROUND OF THE INVENTION

1. Field of the Invention

The present invention relates to LED (Light Emitting Diode) lighting and in particular to a new self contained high power LED cooling system to solve the problem of high power LED chip heat dissipation with a compact, convenient and rapid device including a safeguard thermal shut-off.

2. Description of Related Art Including Information Disclosed Under 37 CFR 1.97 and 1.98

High intensity Light Emitting Diodes (LEDs) have become a very effective light source with low energy consumption compared with incandescent lights. A major problem with the high intensity LEDs is the undesirable level of heat produced by the LEDs.

An aluminum radiator has been used in prior art to dissipate the heat in a high power LED light. This is not adequate due to size and weight restrictions in a lighting fixture. Prior art devices tend to be expensive and sometimes overly complex and without a failsafe means.

U.S. Patent Application #20060198149, published Sep. 7, 2006 by Jonsson, discloses Light Emitting Diode (LED) based lamps with thermoelectric heat management utilizing thermoelectric modules for improving the efficiency of the lamps. The invention provides in a first aspect a light illuminating device that comprises at least one light emitting diode (LED), at least one thermoelectric module (TEM) having a first surface which is thermally connected to the LED, a heat sink thermally connected to a a second surface of the at least one TEM, a thermally insulating cover creating a chamber substantially insulating the LED from ambient air. The LED may be of any conventional type, the invention however is particularly useful for devices using hi-flux LEDs, including traffic lights, illuminated roadway and/or emergency signs, airport runway lights and such.

Two U.S. Patent Applications, #20040155251 published Aug. 12, 2004 and #20060237730 published Oct. 26, 2006 by Abramov, describe a Peltier cooler integrated with electronic device(s). A Peltier effect cooling device is formed in combination with an electronic device to form a unique thermal and electrical relationship. An electronic device to be cooled is placed in a serial electrical relationship between at least two thermoelectric couples while simultaneously being in thermal contact with a cold side of the cooler arrangement. The same current which produces the thermoelectric effect in the Peltier thermocouples also drives the electronic device. A balanced effect results as a higher driving current through the electronic device causes greater heating, it is offset by the added cooling due to a greater current in the thermocouples. In addition, a unique spatial arrangement provides improved heat distribution and transfer to a heat sink. Due to the unique shapes of Peltier elements, heat is pulled radially from a heat generating source and distributed at a peripheral region. Shaped Peltier elements are tapered from a small cold area to a large hot area to further magnify the transfer of heat.

U.S. Patent Application #20060151801, published Jul. 13, 2006 by Doan, indicates a light emitting diode with a thermo-electric cooler. Systems and methods are provided for fabricating a light emitting diode include depositing one or more metal layers on a substrate; forming an n-gallium nitride (n-GaN) layer above the metal layer; and depositing a thermoelectric cooler in the metal layer to dissipate heat.

U.S. Patent Application #20050254013, published Nov. 17, 2005 by Engle, puts forth a projection apparatus which comprises a Light Emitting Diode (LED) and a cooling arrangement.

U.S. Patent Application #20050276053, published Dec. 15, 2005 by Nortrup, illustrates thermal management methods and apparatus for lighting devices. Methods and systems are provided for providing active and passive thermal or cooling facilities for LED lighting systems, including radiating and convective thermal facilities, including fans, phase change materials, conductive polymers, potting compounds, vents, ducts, and other thermal facilities. In FIGS. 71-75, an LED light bulb is shown.

Three U.S. Pat. No. 7,176,502 issued Feb. 13, 2007; U.S. Pat. No. 7,098,483 issued Aug. 29, 2006; and U.S. Pat. No. 7,095,053 issued Aug. 22, 2006 to Mazzochette, show light emitting diodes packaged for high temperature operation. An LED packaged for high temperature operation comprises a metal base including an underlying thermal connection pad and a pair of electrical connection pads, an overlying ceramic layer, and a LED die mounted overlying the metal base. The LED is thermally coupled through the metal base to the thermal connection pad, and the electrodes are electrically connected to the underlying electrical connection pads. A low thermal resistance insulating layer can electrically insulate other areas of die from the base while permitting heat passage. Heat flow can be enhanced by thermal vias to the thermal connector pad. Ceramic layers formed overlying the base can add circuitry and assist in distributing emitted light. The novel package can operate at temperatures as high as 250. degree. C.

U.S. Pat. No. 6,428,189, issued Aug. 6, 2002 to Hochstein, claims L.E.D. thermal management. A heat dissipater of a metallic or metal material is disposed in parallel relationship to a circuit board. The assembly is characterized by the circuit board 12 presenting a hole therethrough and surrounding each of a plurality of LEDs. A heat sink integral with each LED is disposed in thermal contact with the heat dissipater for conveying heat from the LEDs to the heat dissipater. In other words, each LED extends through the hole in the circuit board with the light emitting portion or lens extending from one of the surfaces of the circuit board and the heat sink extending from the other one of the surfaces of the circuit board. A thermal coupling agent is disposed between the heat sink and the heat dissipater for providing a full thermal path between the heat sink and the heat dissipater. In FIG. 3, the first surface of the circuit board, with the electrical leads soldered or adhesively attached to the traces thereon, faces the heat dissipater. The circuit board is spaced from the heat dissipater and, in FIG. 3, the traces face the heat dissipater. A step in the fabrication of the invention is the disposing of a thermally insulating cap around the heat sink while disposing the LED on the circuit board to protect the LED from damage during soldering.

U.S. Pat. No. 7,172,314, issued Feb. 6, 2007 to Currie, describes a solid state light electric bulb for attachment to a lamp socket. The light bulb uses a number of super bright LEDs or color LEDs mounted within a hollow housing to replace a standard bulb such as a 60 Watt bulb. A stepped, reverse conical interior wall distributes and diffuses the light to project the appearance of a normal bulb. An upper lens of the housing may be removable to form a spot light effect.

U.S. Pat. No. 6,948,829, issued Sep. 27, 2005 to Verdes, discloses a light emitting diode (LED) light bulb that includes plural individual elements as sub-assembly elements of the overall light bulb. Different sub-assembly elements of a lens, a LED printed circuit board, a housing also functioning as a heat sink, a lower housing, and other individual sub-assembly components are utilized. The LED printed circuit board sub-assembly containing the LEDs can also be provided relatively close to a base.

Two U.S. Pat. No. 6,220,722 issued Apr. 24, 2001 and U.S. Pat. No. 6,499,860 issued Dec. 31, 2002 to Begemann, indicate an LED lamp having a gear column which is connected, at its first end, to a lamp cap and, at its other end, to a substrate. The substrate is provided with a regular polyhedron of at least four planes, the planes having at least one LED having a luminous flux of at least 5 lm. The gear column also has heat-dissipating means which interconnect the substrate and the lamp cap. A continuous and regular illumination with a high luminous flux can be obtained using a LED lamp of this type.

What is needed is a self contained high power LED cooling system to solve the problem of high power LED chip heat dissipation in a compact, convenient and rapidly acting device which includes a safeguard thermal shut-off.

### BRIEF SUMMARY OF THE INVENTION

An object of the present invention is to provide a a self contained high power LED cooling system to solve the problem of high power LED chip heat dissipation in a compact, convenient and rapidly acting device which includes a safeguard thermal shut-off.

In brief, the present invention is a self contained cooling system for a high power Light Emitting Diode (LED) chip. A cooling aluminum radiator having fins draws heat away from the LED chip with further heat removal from the radiator with a high efficiency cooling fan, such as a fan used in a central processing unit (CPU) of a computer with a built-in self-contained power supply both for the fan and for the LED chip current regulation and voltage regulation. The cooling system removes the extreme high temperature from the high power LED chip during its operation. The present invention is highly effective as a high intensity light for use in public and commercially lighting systems, such as street lights and lights in large indoor and outdoor commercial spaces requiring bright lighting.

Both the high power LED and the cooling system is powered by a self contained power supply. This power supply unit supplies both the LED with current regulation and voltage regulation. The secondary supply is for the cooling fan.

This assembly has a high expansion/contraction factor because of the high temperatures involved. This is compensated for by the use of four springs in the peripheral structural posts which connect all of the components together. In the event of a fan failure, the present invention has an automatic protection built in. A thermocouple device is located on the aluminum radiator and the high power LED chip which monitors the temperature. Should the aluminum radiator reach a pre determined level, the power supply is shut off, thus saving the high power LED from failure.

This system is designed to handle any high power LED chips in any form, from 1 watt, 3 watt, 5 watt, 10 watt, 15 watt, 20 watt 25 watt, 30 watt, 35 watt, 40 watt, 45 watt, 50 watt, 60 watt, 70 watt, 80 watt, 90 watt, 100 watt, 150 watt and above.

The cooling system also removes the heat from the power supply due to the fan blowing.

An advantage of the present invention is that it provides a built-in cooling and power system for high power LED chips for use in high intensity lighting.

Another advantage of the present invention is that the CPU fan has a long life and will work continuously.

One more advantage of the present invention is that it provides a failsafe system so that the LED chip will not be overheated.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a perspective view of the LED cooling system of the present invention with the built in power source, heat radiator, fan and thermo couple control;

FIG. 2 is a perspective view of the LED cooling system of FIG. 1;

FIG. 3 is a side elevational view of the LED cooling system of FIG. 1 showing the butterfly plate and the LED chip aligned for assembly with the other components;

FIG. 4 is a top plan view of the heat radiating element of FIG. 1;

FIG. 5 is a top plan view of he fan of FIG. 1;

FIG. 6 is a side elevational view of the present invention attached to a bulb element for a street light fixture;

FIG. 7 is a side elevational view of the present invention attached to a bulb element for an industrial light fixture.

### DETAILED DESCRIPTION OF THE INVENTION

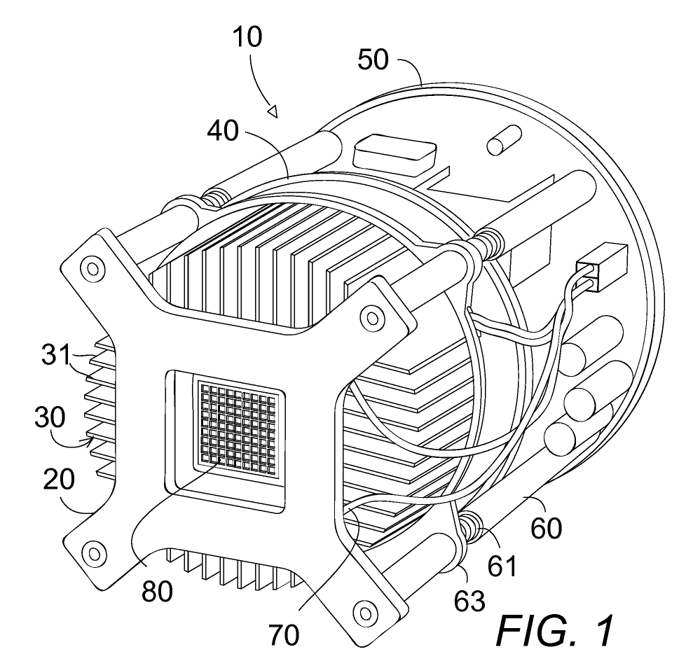

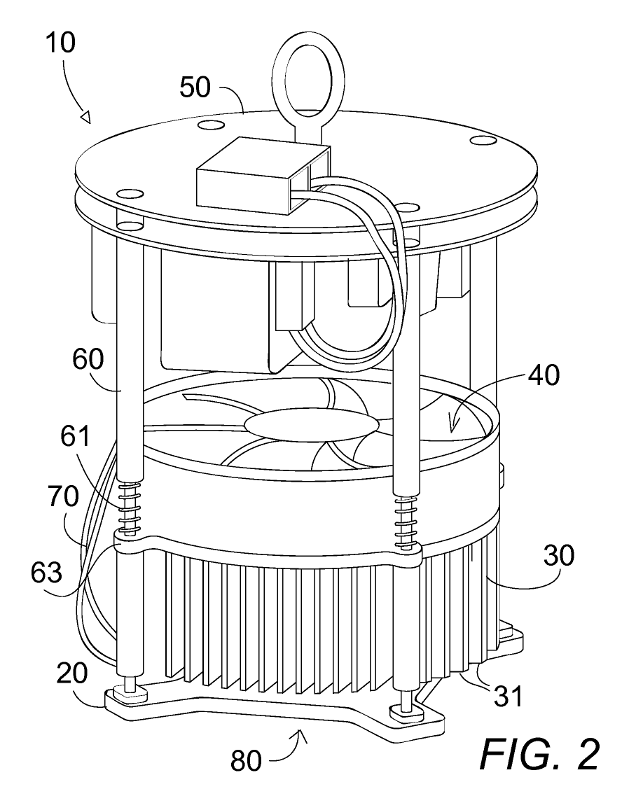

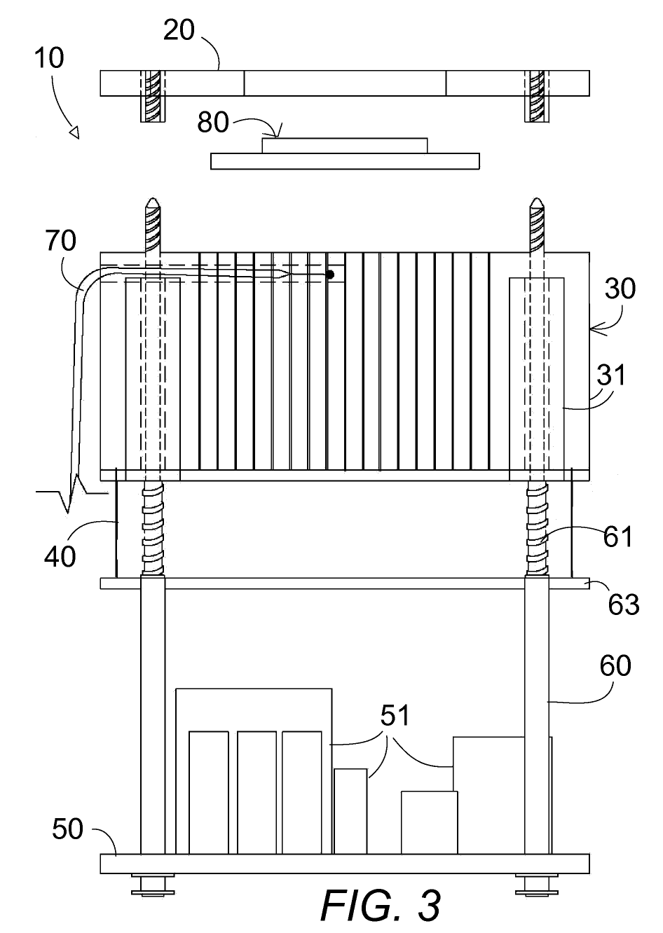

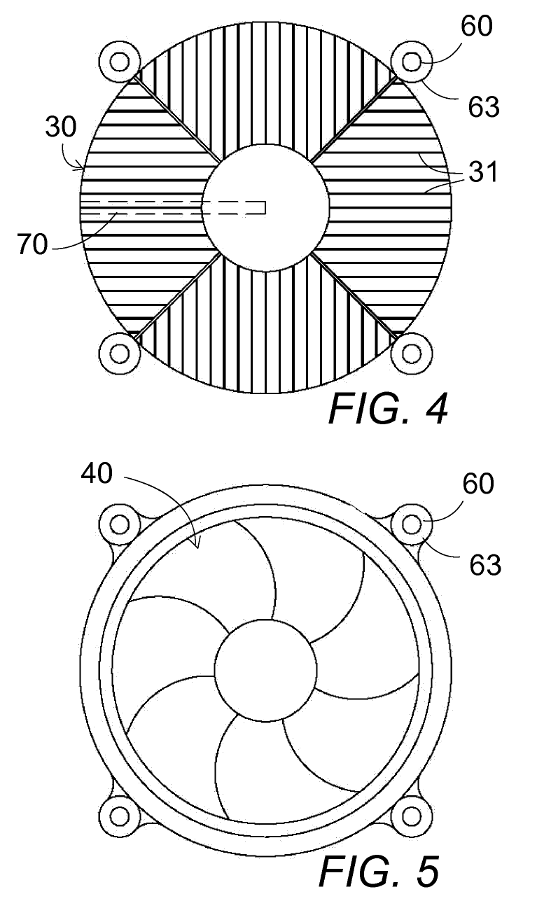

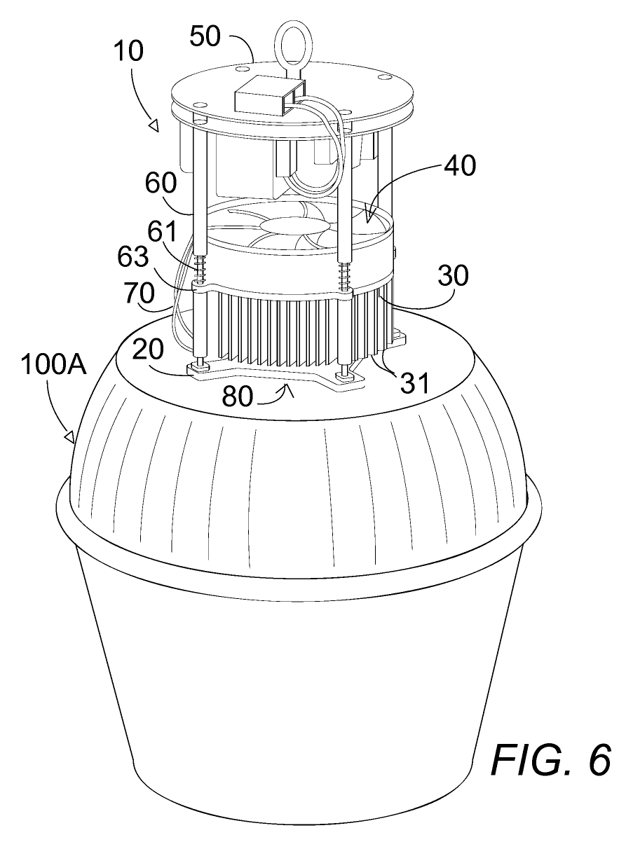

In FIGS. 1-7, a Light Emitting Diode (LED) cooling system 10 comprises a connected LED chip 80, heat radiator 30, fan 40, and self-containing power supply 50.

The heat dissipating radiator 30 is positioned adjacent to a high power Light Emitting Diode (LED) chip 80 and extends orthogonally away from the LED chip to draw heat away from the LED chip. The heat dissipating radiator 30 comprising a series of spaced parallel aluminum fins 31 positioned orthogonally to the LED chip to draw heat away from the LED chip 80 and admit cooling air from the fan 40 to pass between the fins. A butterfly plate 20 holds the LED chip 80 in place with a center opening in the butterfly plate 20 admits the light out.

The fan 40 is positioned adjacent to the radiator 30 for cooling the radiator and the LED chip 80 as well as cooling the built-in power supply 50. The fan 30 preferably comprises a long life continuous operation fan, such as the highly efficient Central Processing Unit (CPU) fan used in computers.

The built-in power supply 50 supplies power both for the fan and the LED chip and regulating the LED chip current regulation and voltage regulation, the fan also cooling the power supply. The built-in power supply 50 has a number of components 51 including a fixed voltage and current connection to the fan and another fixed voltage and current connection to the LED chip.

A fail safe thermocouple device 70 contacting the radiator 30 preferably in the center thereof adjacent to the LED chip 80 for detecting the temperature of the radiator 30 near the LED chip. The thermocouple device 70 activates a shut off switch to turn off the power supply to the LED chip when the temperature of the radiator is close to the failure temperature of the LED chip to prevent destruction of the LED chip from overheating.

A series of rods 60 with springs 61 interconnecting the LED chip 80, the radiator 30, the fan 40, and the power supply 50 which may each be attached to a separate platform or ring with connecting loops 63 so that the springs absorb the expansion and contraction of the system due to heating and cooling.

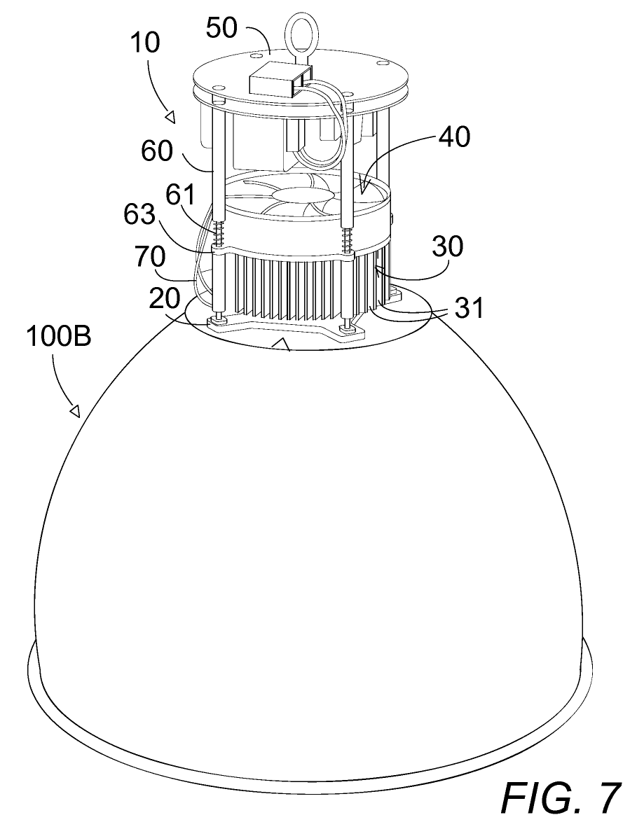

In FIGS. 6 and 7, the LED cooling device 10 of the present invention is shown connected with a large street light globe 100A, in FIG. 6, and a large industrial light globe 100B to transmit the light from the high power LED chip therethrough for use in industrial and commercial lighting.

The present invention provides the use of the heat radiator and high efficiency CPU fan as the cooling system for high power LED chips in any form, from 1 watt, 3 watt, 5 watt, 10 watt, 15 watt, 20 watt, 25 watt, 30 watt, 35 watt, 40 watt, 45 watt, 50 watt, 60 watt, 70 watt, 80 watt, 90 watt, 100 watt, 150 watt and above.

In use, the high power LED chip lighting with built-in cooling and power supply may be installed in any desired light fixture to produce high intensity light from the LED chip while the fan rotates and the aluminum radiator becomes cool as does the high power LED chip.

If the temperature of the high power LED chip goes above 60 degrees Centigrade, the thermocouple in the center of the aluminum radiator will signal the power supply to shut off.

This present invention is used for efficiency. All that is required is a high efficiency CPU fan to continuously revolve thus the high power LED chip remains cool at below 60 degrees Centigrade.

It is understood that the preceding description is given merely by way of illustration and not in limitation of the invention and that various modifications may be made thereto without departing from the spirit of the invention as claimed.

What is claimed is:

1. A Light Emitting Diode (LED) cooling system comprising:
a heat dissipating radiator positioned adjacent to a high power Light Emitting Diode (LED) chip and extending orthogonally away from the LED chip to draw heat away from the LED chip;
a fan adjacent to the radiator for cooling the radiator and the LED chip;
a built-in power supply for supplying power both for the fan and the LED chip and regulating the LED chip current regulation and voltage regulation, the fan also cooling the power supply; thereby providing a built-in LED cooling system with a built-in power supply for use in high intensity lighting.

2. The system of claim 1 further comprising a fail safe thermocouple device contacting the radiator adjacent to the LED chip for detecting the temperature of the radiator, the thermocouple device activating a shut off switch to turn off the power supply to the LED chip when the temperature of the radiator is close to the failure temperature of the LED chip to prevent destruction of the LED chip from overheating.

3. The system of claim 1 wherein the fan comprises a long life continuous operation fan.

4. The system of claim 3 wherein the long life continuous operation fan comprises a Central Processing Unit (CPU) fan used in computers.

5. The system of claim 1 further comprising a series of rods with springs interconnecting the LED chip, the radiator, the fan, and the power supply to absorb the heat expansion and contraction of the system.

6. The system of claim 1 wherein the radiator comprising a series of spaced parallel aluminum fins positioned orthogonally to the LED chip to draw heat away from the LED chip and admit cooling air from the fan to pass between the fins.

7. The system of claim 1 wherein the built-in power supply comprises a fixed voltage and current connection to the fan and another fixed voltage and current connection to the LED chip.
